(19) United States
(12) Patent Application Publication
(10) Pub. No.: US 2005/0151979 A1
(43) Pub. Date: Jul. 14, 2005

(54) Optical measuring device and optical measuring method

(76) Inventor: Gerd Siekmeyer, Pforzheim (DE)

Correspondence Address: FISH & RICHARDSON P.C., P.O. BOX 1022, MINNEAPOLIS, MN, 55440-1022, US

(21) Appl. No.: 11/002,958

(22) Filed: Dec. 3, 2004

(30) Foreign Application Priority Data
Dec. 4, 2003 (DE) 103 56 765.8

(51) Int. Cl. G01B 11/14

(52) U.S. Cl. 356/625

(57) ABSTRACT

The present invention relates to an optical measuring device comprising an illumination system, a CCD camera and an image processing device for determining the dimensions of hollow or tubular miniature components, in particular stents. For this purpose the stent is slid onto an object slide and rotated in order to image it from all sides by means of the camera. The structure of the object slide is such that, before exiting, incoming light is multiply refracted by said structure, so that the object slide gives off an essentially homogeneous light, i.e. so that each surface element of the light outlet surface has essentially the same radiation intensity.

### CROSS-REFERENCE TO RELATED APPLICATION

The present application claims priority to German Application No. 103 56 765.8 filed Dec. 4, 2003, which is incorporated herein by reference.

### BACKGROUND

The present invention relates to an optical measuring device for the optical measuring of miniature components, as well as to a corresponding method.

By means of light contrast, optical dimension measuring of miniature components such as for example medical ampoules, stents and the like is possible. The optical contrast is generated either in the incident light method or in the transmitted light method.

In the incident light method, light from a suitable light source impinges on the object to be measured from above, with the reflected light being imaged by a camera in order to measure the object to be measured by means of the image taken. In the so-called transmitted light method, the object to be measured is illuminated by a light source from one side, with the light which passes through the object to be measured being imaged on the other side by a camera and being evaluated.

Document DE-A 40 33 588 discloses one example of an incident light method. In this arrangement, workpiece surfaces, in particular of profile cross-sections, are optically measured by means of a camera and an illumination unit. The illumination unit, which is arranged so as to be offset in relation to the object axis, shines on the object to be measured, with the light being reflected by said object to be measured. A camera is arranged so as to be rotated by a certain angle in relation to the object axis, and images the light reflected by the object to be measured. The dimensions of the object can be determined by the high-contrast image taken by the camera.

However, this measuring method does not achieve satisfactory results with all materials, since image sharpness and contrast very much depend on the reflection of the material.

Document DE-A-41 11 145 describes a method for monitoring dimensional accuracy of medical ampoules, which method uses the transmitted light method. In this arrangement, an ampoule to be checked is illuminated perpendicularly to its longitudinal axis by means of a diffusely radiating light source, and is rotated on its longitudinal axis. The light passing through the ampoule is imaged by a camera system and is transformed into electrical image signals. These image signals are then used to carry out a variance comparison in order to check the test sample for dimensional accuracy.

In the case of hollow products such as hollow profiles, small tubes, stents and the like, the transmitted light method is however associated with the disadvantage of shadows being cast from the wall and web flanks of the walls which are opposite the measured wall, with said web flanks generating a wider web dimension.

In order to minimise such shadows being cast, up to now a hollow object to be measured has been slid onto an object slide made of glass (sapphire glass or borosilicate glass). This object slide is frosted by corresponding surface treatment (etching, grinding and/or sand blasting) in order to minimise shadow images and in order to improve the directional characteristics of the light.

However, the light intensity required in this arrangement for compensating the absorption generally results in edge irradiation and in smaller, i.e. incorrect, dimension values being measured. Furthermore, the above-mentioned surface treatment of the object slide generates uneven illumination effects and break-outs, which lead to further measuring errors. Moreover, it is thus not possible to achieve targeted and controlled radiation and thus masking of the side flanks of a web to be measured, which side flanks have come into the image as a result of the possible wall thickness geometry.

FIG. 3 shows the application of the transmitted light method with an object slide 1 according to the state of the art. A light beam impinging the object slide 1 from the light source 2 is transmitted through the object slide 1 and falls onto the camera (not shown in FIG. 3). At the webs 7, the light is reflected or absorbed so that these positions do not transmit any light to the camera.

FIG. 5 shows the image taken by the camera in a transmitted light method according to the state of the art. In this image, the webs 7 which have been irradiated directly by the light source 2 appear as black shadows, thus hindering precise dimension evaluation of the object to be measured.

Furthermore, U.S. Pat. No. 5,825,666 describes a coordinate measuring device comprising a video camera, which can be moved relative to the object to be measured, and a contact sensor which can be installed on the video camera. In this arrangement, the contact sensor is movable in relation to the video camera, and a target, fixed to a contact point of the contact sensor, is imaged in a focal plane of the video camera.

### SUMMARY

According to the invention, the object is met by an object slide made from a translucent material for imaging an object to be measured which is essentially hollow, with the structure of said object slide being such that incident light prior to exiting is refracted and/or diffused in such a way that the object slide gives off an essentially homogeneous light.

By multiple refraction or diffusion of the light in the object slide, and the resulting homogeneous light radiation of the object slide, interfering shadows can be prevented and the contrast of the imaged elements of the object to be measured can be enhanced because shadow formation is essentially avoided.

In this document, the term homogeneous radiation refers to the circumstance that each surface element of the light outlet surface has essentially the same radiation intensity.

Preferably, the object slide is at least partially made of an opal glass.

The turbidity value of the object slide should exceed 10 FTU (Formazine Turbidity Units), and/or to increase turbidity, particles are admixed whose granular size is less than 100 μm. In this way the incoming light is multiply diffused and/or refracted so that the structure of the object to be measured is essentially homogeneously lit on the side to be measured even if the structure of the measured object on the side opposite the side to be measured casts shadows.

The crystal-like structures reflect the incident light diffusely, thus causing multiple refraction so that the object slide radiates homogeneously, and interfering shadows from the side of the object to be measured, which side faces the light source, are avoided.

The admixed particles can contain fluorite and/or zirconium oxide, or particles containing cryolite (NA₃AIF₆). In this way, droplet-shape microcrystalline structures form in the glass.

Elements such a lead glass, phosphorous oxide, iron or Al₂O₃ can be incorporated into the glass melt in order to achieve suitable opaqueness of the object slide.

Furthermore, particles of cryolite (Na₃AIF₆) in droplet form and/or elements such as lead crystal, phosphorus oxide, iron or Al₂O₃ can be incorporated into the glass melt in order to achieve suitable opaqueness of the object slide.

Preferably the energy loss of a light beam impinging on the opaque glass is at least 15%, while the refraction indices radially and axially in relation to the rotational axis of the object slide do not differ from each other by more than 15%.

Preferably the light source for illuminating the object to be measured and the object slide is a programmable spotlight source whose luminous intensity can be controlled or regulated by means of frequency modulation or pulse-width modulation.

In this arrangement the wavelength of the light should range between approximately 300 nm and 1200 nm. The colour of the light can be produced by combining several spectral colours.

Preferably a CCD camera is used for taking an image of the illuminated object to be measured. For evaluation to determine the dimensions, a program-controlled image processing device is used for processing the images taken by the CCD camera.

According to the invention, an optical measuring method involving the following steps is created: provision of an object slide from a translucent material for imaging an essentially hollow object to be measured; illumination of the object to be measured and of the object slide by means of a light source; taking an image of the illuminated object to be measured by means of a camera; processing of the image taken for the purpose of determining the dimensions; wherein the structure of the object slide is such that incident light is multiply refracted before exiting so that the object slide gives off an essentially homogeneous light.

It is thus an object of the invention to allow improved optical measuring of miniature components.

The above and any other objects, characteristics and advantages of the invention will become clearer after reading the following description in conjunction with the added drawings.

### DESCRIPTION OF DRAWINGS

FIG. 1 shows an arrangement according to the invention, of the components for measuring the miniature components;

FIG. 2 diagrammatically shows the structure of a stent as an example of a miniature component to be measured;

FIG. 3 shows the application of the transmitted light method for measuring a stent shown in FIG. 2 with a glass slide, which is frosted on the surface, according to the state of the art as an object slide for holding the stent;

FIG. 4 shows the application of the transmitted light method for measuring a stent shown in FIG. 2 by means of an opal glass slide as an object slide for holding the stent;

FIG. 5 shows an image taken when using the arrangement shown in FIG. 3; and

FIG. 6 shows an image taken when using the arrangement shown in FIG. 4.

Below, the invention is explained in detail with reference to the drawings.

### DETAILED DESCRIPTION

By means of examples, the invention is shown during the process of measuring so-called stents, i.e. tubular hollow products for placement in blood vessels, for example in the context of heart surgery.

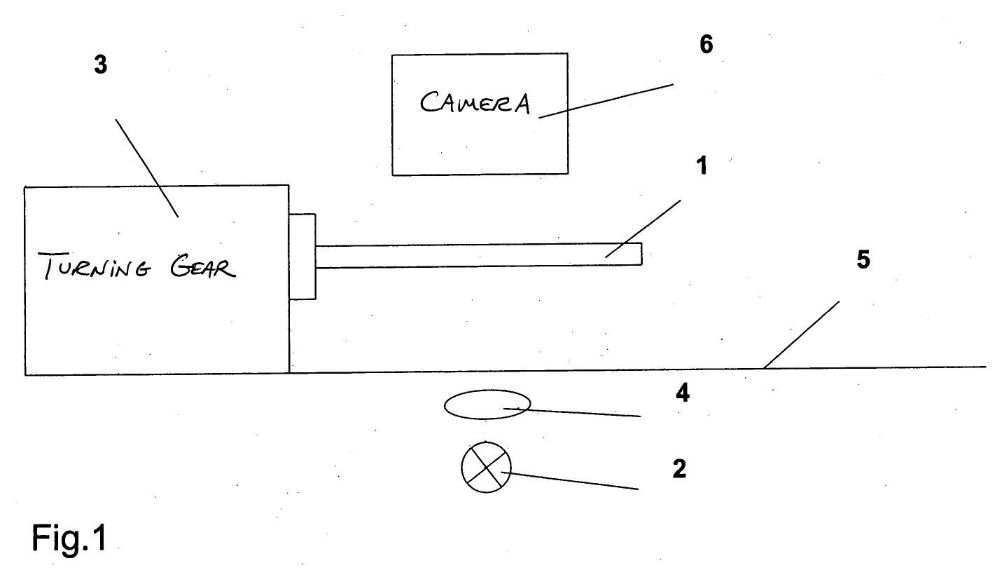

As shown in FIG. 1, an essentially cylindrical or bar-shaped object slide 1 made of glass, preferably of opal glass, is clamped into the chuck of a turning gear 3. A light source 2 as well as a convex lens with a grey filter 4 and a glass plate 5 are arranged in said order in a radially or laterally offset arrangement in relation to the object slide 1. On the side opposite the light source 2, a camera 6 (for example a CCD camera) is arranged.

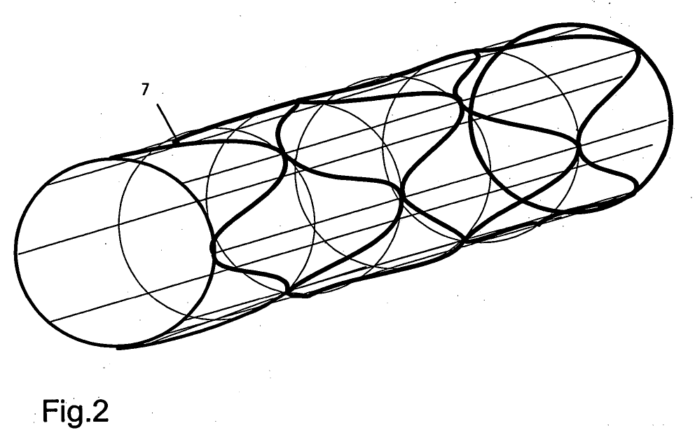

The object to be measured (not shown in FIG. 1) is slid onto the object slide 1 with little play and is illuminated from the side by the light source 2. The object to be measured can for example be a hollow tubular miniature component, as shown in FIG. 2, which comprises webs 7 in its cylindrical outside wall.

The object to be measured, which is illuminated from one side by the light source 2, is imaged by means of the camera 6, essentially from the opposite side (in the transmitted light method).

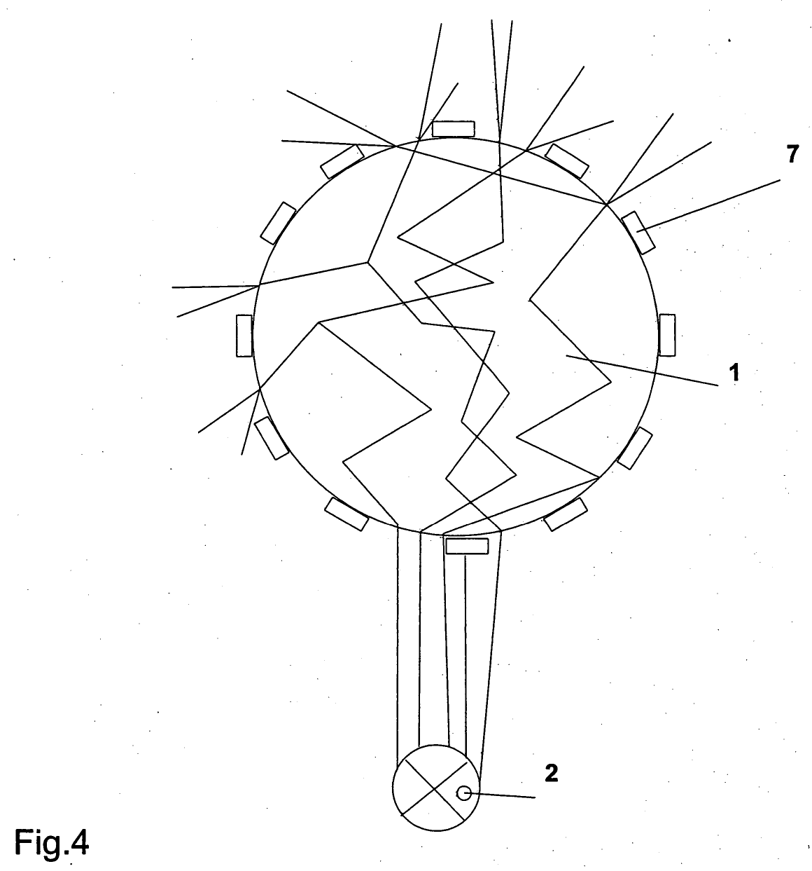

Preferably, a glass slide made of opal glass is used as an object slide 1. The special opaqueness or milky design of this opal glass is preferably achieved by adding fluorite particles or zirconium oxide particles. As shown in FIG. 4, these additives generate crystal-like structures which diffusely reflect or multiply diffuse and/or refract the incident light in all directions.

However, it is also possible to add a cryolite Na₃AIF₆ in the form of droplets of approximately 100 nm in size. Furthermore, impurities can be used as additives, for example lead glass, phosphorus oxide, iron, Al₂O₃ and the like.

Preferably, the quantity of additives is such that the energy loss of a transmitted light beam is at least approximately 15%. Furthermore, the refraction indices horizontally and vertically in relation to the rotational axis (axially and radially) of the object slide 1 do not differ from each other by more than approximately 15%.

The opaqueness of the opal glass results in even and enhanced luminosity in the object slide 1. Furthermore, costly additional treatment of the material, for example by etching or sand blasting, is not required.

In the counterlight, the opal glass generates an unsharp and slightly green, grey or white chrominance, depending on the type of the incorporated sediments. Preferably, the turbidity value of the object slide exceeds 10 FTU (Formazine Turbidity Units) so that multiple refraction of the incident light beam occurs, and/or the granular size of the sediments used is preferably less than 100 μm. In this way a multitude of diffusion centres and/or refraction centres are distributed in the material of the object slide 1, which diffusion centres and/or refraction centres result in essentially homogeneous radiation.

Thus, as a result of multiple refraction or multiple diffusion of the incident light, the object slide 1 is made to produce homogeneous light radiation, i.e. the light source for imaging is displaced into the object slide 1. Shadows as a result of surface errors can be compensated for solely by controlling the light intensity so that subsequent material processing can be saved.

The object slide 1 can also be designed such that only the region onto which the object to be measured is slid is opaque, while the region which is clamped into the chuck of the turning gear 3 can have any other desired configuration.

There is no need for the object slide 1 to be made in one piece; instead it can comprise a first section made of opal glass and a second section made of any other material such as for example plastic, metal etc. In this arrangement the first section can be used to accommodate the object to be measured while the second section is used for insertion into the chuck of the turning gear 3. The two sections can be interconnected by any desired connection method such as adhesion, plugging, screwing, forming etc.

In a preferred embodiment the light source 2 is closer to the object to be measured when compared to the arrangement in the state of the art. By avoiding edge irradiation, i.e. by improved edge illumination, edge detection becomes more accurate because the object slide 1 radiates its light homogeneously. Moreover, the light intensity can be homogeneously adjusted and calibrated to the object structure to be measured.

The light source 2 comprises a strong spotlight source, preferably with a luminous intensity of at least 1 lumen per watt, as well as opaque but slightly transparent opal glass. Preferably, the luminous intensity of the light source 2 can be controlled or regulated in an infinitely variable manner in the frequency modulation method or pulse-width modulation method. Furthermore, the intensity of the illumination or the illumination area is preferably adjustable by way of an iris diaphragm or by way of interchangeable lenses.

Depending on the type of the object to be measured, the light used can be at different wavelengths, preferably however ranging from approximately 300 nm to 1200 nm. In this arrangement, the colour of the light can also be generated by combining several spectral colours.

In the method according to the invention, the arrangement of the light source 2 is not limited to the arrangement from the side, shown in FIG. 1, which arrangement is normal in the transmitted light method. Since the object slide 1 as a result of multiple refraction and/or multiple diffusion radiates an essentially homogeneous light, the light can also be brought into the object slide 1 from all other sides; even an axially arranged light source is possible.

If the light source 2 is arranged axially, it can be positioned opposite the turning gear 3. However, said light source 2 can also be integrated in said turning gear 3 in order to improve the handling characteristics of the entire device.

However, any other arrangement of the light source 2 is possible, for example transversely from above or below or similar, as long as the arrangement of the light source 2 is selected such that the light is homogeneously radiated by the radiating object slide 1.

The method described is in particular suitable for optically measuring a so-called stent, as shown in FIG. 2. This stent is made from a wire mesh with webs 7, and comprises an essentially cylindrical form.

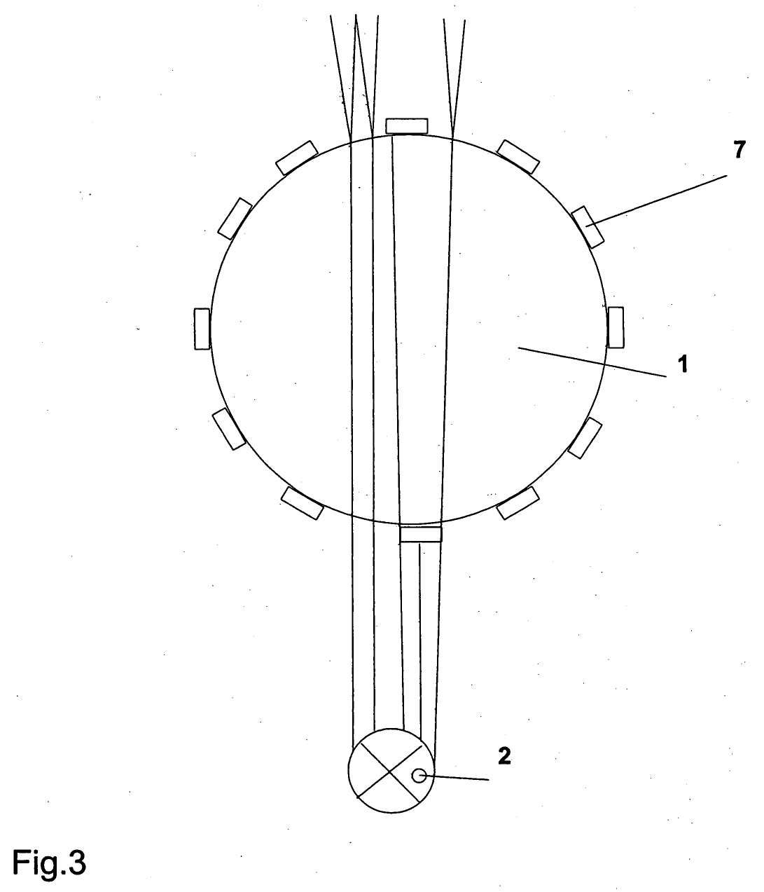

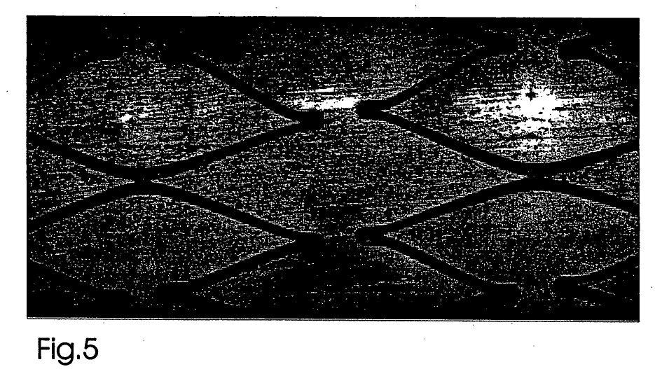

Below, the advantages of the present invention are explained with reference to FIGS. 3 to 7.

While FIG. 3 shows the device according to the state of the art, FIG. 4 shows the device according to the invention. The light impinging the object slide 1 from the light source 2 is multiply refracted by said object slide 1 and is homogeneously radiated in all directions. As already mentioned above, in this arrangement, contrary to the transmitted light method according to the state of the art (as shown here), the light source 2 need not be arranged radially in relation to the object to be measured and diametrically opposed to the camera 6, but instead, said light source 2 can for example be arranged axially in relation to said object to be measured. Since the object slide 1 according to the invention diffuses the light by multiple refraction and radiates the light essentially homogeneously, the arrangement of the light source 2 can be varied.

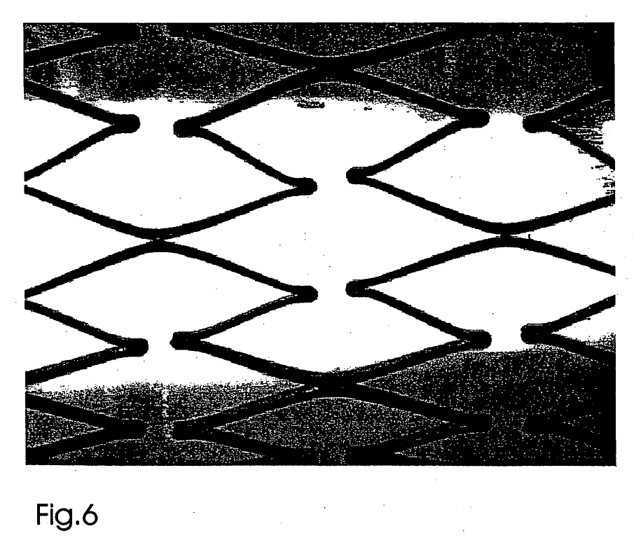

Moreover, a web 7 situated on the side of the light source 2 does not form an interfering shadow because the incident light on both sides of such a web 7 is evenly diffused or refracted in the object slide 1. Instead, the webs 7 situated on the side of the camera 6 are clearly detectable on the image taken, as shown in FIG. 6, while the webs 7 which are directly subject to radiant exposure essentially do not cast any shadows.

In particular, a comparison of FIG. 4 with FIG. 6 demonstrates the advantage of taking images with the method according to the invention.

For determining dimensions, these images are evaluated by means of electronic image processing. To this effect, the position of the rotary axis of the object slide 1 is determined in a coordinate system, and the position of the shadow elements on the images generated is used for determining the dimensions and positions of the individual elements of the object to be measured, such as for example the webs 7.

The object to be measured can thus be accurately measured even in the sub-micrometer range.

However, the invention is not limited to cylindrical hollow products such as the stent shown, but can also be used in other hollow products such as for example in rectangular hollow products, extruded sections or U-sections. The object slide can be of a shape which is adapted to the respective object to be measured. Furthermore, the object to be measured need not be a hollow product. Instead, any component or product with a light inlet area and a light outlet area can be measured using the device according to the invention.

Furthermore, the object slide 1 can have a structure which, for example by way of a crystal structure, produces multiple refraction of the incident light in order to achieve the above-described effect of homogeneous light radiation of the object slide 1.

It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

List of Reference Numbers

1 Object slide
2 Light source
3 Turning gear
4 Convex lens with grey filter
5 Glass plate
6 Camera
7 Web

1. An object slide comprising a translucent material for accommodating an essentially hollow object to be measured, wherein the structure of the object slide is such that incoming light is multiply refracted and/or diffused by it so that the object slide gives off an essentially homogeneous light.

2. The object slide according to claim 1, wherein the object slide is made at least partly from opal glass.

3. The object slide according to claim 1, which has a turbidity value that exceeds 10 FTU, and/or wherein the granular size of particles admixed for the purpose of opaqueness is less than 100 μm.

4. The object slide according to claim 1, wherein admixed particles comprise at least fluorite and/or zirconium oxide.

5. The object slide according to claim 1, wherein admixed particles comprise cryolite (Na₃AIF₆) which produces a droplet-like microcrystalline structure in the glass.

6. The object slide according to claim 1, wherein admixed particles comprise at least one element comprising lead glass, phosphorus oxide, iron or Al₂O₃.

7. The object slide according to claim 1, wherein the energy loss of a transmitted light beam is at least 15%, and/or the refraction indices radially and axially in relation to the rotational axis of the object slide do not differ from each other by more than 15%.

8. An illumination system for an optical measuring device comprising: an object slide according to claim 1; and a light source for illuminating the object to be measured and the object slide.

9. The illumination system according to claim 8, wherein the light source comprises a programmable spotlight source whose luminous intensity can be controlled or regulated by means of frequency modulation or pulse-width modulation.

10. The illumination system according to claim 8, wherein the wavelength of the light ranges between 300 nm and 1200 nm, and the colour of the light can be produced by combining several spectral colours.

11. An optical measuring device comprising:
an illumination system according to any one of claims 8;
a CCD camera for taking an image of the illuminated object to be measured; and
an image processing device for processing the images taken by the CCD camera for evaluation to determine the dimensions.

12. An optical measuring method comprising the following steps:
provision of an object slide from a translucent material for imaging an essentially hollow object to be measured;
illumination of the object to be measured and of the object slide by means of a light source; taking an image of the illuminated object to be measured by means of a camera;
processing of the image taken for the purpose of evaluation to determine the dimensions;
wherein the structure of the object slide is such that incident light is multiply refracted before exiting so that the object slide gives off an essentially homogeneous light.
